(19) United States
(12) Patent Application Publication
(10) Pub. No.: US 2021/0134086 A1
(43) Pub. Date: May 6, 2021

(54) DATA TRANSMISSION METHOD IN VEHICLE COMMUNICATION INTERFACE APPARATUS AND VEHICLE COMMUNICATION INTERFACE APPARATUS

(71) Applicant: AUTEL INTELLIGENT TECHNOLOGY CORP., LTD., Shenzhen (CN)

(72) Inventor: Yun JIANG, Shenzhen (CN)

(21) Appl. No.: 17/146,015

(22) Filed: Jan. 11, 2021

Related U.S. Application Data
(63) Continuation of application No. PCT/CN2019/129877, filed on Dec. 30, 2019.

(30) Foreign Application Priority Data
Dec. 29, 2018 (CN) 2018116391713

(51) Int. Cl. G07C 5/08; H04L 12/861; G06F 9/48; B60R 16/023

(52) U.S. Cl. CPC G07C 5/0808; H04L 49/90; H04L 2012/40273; B60R 16/0234; G06F 9/4881

(57) ABSTRACT

Embodiments of the present invention relate to the field of vehicle diagnosis technologies, and specifically disclose a data transmission method in a vehicle communication interface apparatus and a vehicle communication interface apparatus. The vehicle communication interface apparatus includes a first controller and a second controller. The data transmission method includes: receiving, by the first controller, a diagnostic command sent by an upper computer, and storing the diagnostic command into a first queue; obtaining, by the second controller, the diagnostic command from the first queue, and sending the diagnostic command to an electronic control unit (ECU) in a vehicle connected to the vehicle communication interface apparatus; and receiving, by the second controller, diagnostic data from the ECU, and storing the diagnostic data into a second queue, to make the first controller obtain the diagnostic data from the second queue and send the diagnostic data to the upper computer. Through the foregoing technical solution, the embodiments of the present invention can respond to the diagnostic command and receive the diagnostic data simultaneously.

The present application claims priority to Chinese Patent Application No. 201811639171.3, filed with the Chinese Patent Office on Dec. 29, 2018, and entitled “DATA TRANSMISSION METHOD IN VEHICLE COMMUNICATION INTERFACE APPARATUS AND VEHICLE COMMUNICATION INTERFACE APPARATUS”, which is incorporated herein by reference in its entirety.

### BACKGROUND

### Technical Field

The present application relates to the field of vehicle diagnosis technologies, and especially, to a data transmission method in a vehicle communication interface apparatus and a vehicle communication interface apparatus.

### Related Art

With the improvement of living standards, transportations such as vehicles, metro trains, and high-speed trains have become necessary means of people for outgoing. Recently, rapid development of the electronics industry enables current transportations to provide a safer and more comfortable service for people.

For ensuring driving safety of a vehicle, a diagnosis needs to be performed on the vehicle regularly, to check performance of the vehicle. A traditional vehicle diagnosis system generally includes an upper computer and a lower computer. The upper computer is connected to the lower computer, and the lower computer is connected to a vehicle bus. The upper computer can send a diagnostic command to the lower computer, and the lower computer transmits the diagnostic command to the vehicle bus. The lower computer may further receive diagnostic data in the vehicle bus and transmit the diagnostic data to the upper computer.

It is found by the inventor in a process of implementing embodiments of the present invention that, a lower computer of a current vehicle diagnosis system cannot respond to a diagnostic command and receive diagnostic data simultaneously.

### SUMMARY

Based on the prior art, embodiments of the present invention provide a data transmission method in a vehicle communication interface apparatus and a vehicle communication interface apparatus which can respond to a diagnostic command and receive diagnostic data simultaneously.

The embodiments of the present invention provide technical solutions as follows:

According to a first aspect, an embodiment of the present invention provides a data transmission method in a vehicle communication interface apparatus, where the vehicle communication interface apparatus includes a first controller and a second controller, and the method includes:

receiving, by the first controller, a diagnostic command sent by an upper computer, and storing the diagnostic command into a first queue;

obtaining, by the second controller, the diagnostic command from the first queue, and sending the diagnostic command to an electronic control unit (ECU) in a vehicle connected to the vehicle communication interface apparatus; and

receiving, by the second controller, diagnostic data from the ECU, and storing the diagnostic data into a second queue, to make the first controller obtain the diagnostic data from the second queue and send the diagnostic data to the upper computer.

According to a second aspect, an embodiment of the present invention provides a vehicle communication interface apparatus, where the vehicle communication interface apparatus includes a first controller and a second controller, where

the first controller is configured to receive a diagnostic command sent by an upper computer, and store the diagnostic command into a first queue;

the second controller is configured to obtain the diagnostic command from the first queue, and send the diagnostic command to an ECU in a vehicle connected to the vehicle communication interface apparatus; and

the second controller is further configured to receive diagnostic data from the ECU, and store the diagnostic data into a second queue, to make the first controller obtain the diagnostic data from the second queue and send the diagnostic data to the upper computer.

Differing from the prior art, beneficial effects of the embodiments of the present invention lie in that, according to the data transmission method in the vehicle communication interface apparatus provided in the embodiments of the present invention, the first controller receives the diagnostic command sent by the upper computer and stores the diagnostic command into the first queue, and the second controller obtains the diagnostic command from the first queue and sends the diagnostic command to the vehicle. The second controller further receives the diagnostic data from the vehicle and stores the diagnostic data into the second queue, and the first controller further obtains the diagnostic data from the second queue, thereby responding to the diagnostic command and receiving the diagnostic data simultaneously in the vehicle communication interface apparatus is implemented, to enable the vehicle communication interface apparatus to perform data communication with the upper computer and the vehicle simultaneously.

### BRIEF DESCRIPTION OF THE DRAWINGS

For describing the technical solutions of the embodiments of the present invention more clearly, a brief introduction on accompanying drawings required in the embodiments of the present invention is made below. Obviously, the accompanying drawings described below are merely some embodiments of the present invention, and a person skilled in the art may obtain other accompanying drawings based on these accompanying drawings without creative efforts.

FIG. 1 is a schematic structural diagram of a vehicle diagnosis system according to an embodiment of the present invention;

FIG. 2 is a schematic structural diagram of a vehicle communication interface apparatus shown in FIG. 1 according to an embodiment of the present invention;

FIG. 3 is a schematic flowchart of a first data transmission method applied to the vehicle communication interface apparatus shown in FIG. 2 according to an embodiment of the present invention;

FIG. 4 is a schematic flowchart of a second data transmission method applied to the vehicle communication interface apparatus shown in FIG. 2 according to an embodiment of the present invention;

FIG. 5 is a schematic flowchart of a third data transmission method applied to the vehicle communication interface apparatus shown in FIG. 2 according to an embodiment of the present invention; and

FIG. 6 is a schematic flowchart of an application example of a data transmission method applied to the vehicle communication interface apparatus shown in FIG. 2 according to an embodiment of the present invention.

### DETAILED DESCRIPTION

To make objectives, the technical solutions, and advantages of the present invention clearer, the present invention is further described in detail with reference to accompanying drawings and embodiments. It is to be understood that the specific embodiments described herein are merely used for interpreting the present invention and are not intended to limit the present invention.

It should be noted that the features in the embodiments of the present invention may be combined with each other if no conflict occurs, and all combinations fall within the protection scope of the present invention. In addition, although functional module division is performed in the schematic diagram of the apparatus and a logical sequence is shown in the flowchart, in some situations, the shown or described steps may be performed by module division different from that in the apparatus or in a sequence different from that in the flowchart. Moreover, words such as “first” and “second” adopted in the present invention do not constitute any limitation on the data and the execution sequence, and merely distinguish same items or similar items of which the functions and roles are basically the same.

A traditional vehicle diagnosis system generally includes an upper computer and a lower computer. The upper computer is connected to the lower computer, and the lower computer is connected to a vehicle bus. The upper computer can send a diagnostic command to the lower computer, and the lower computer transmits the diagnostic command to the vehicle bus. The lower computer may further receive diagnostic data in the vehicle bus and transmit the diagnostic data to the upper computer. However, a lower computer of a current vehicle diagnosis system cannot respond to a diagnostic command and receive diagnostic data simultaneously.

Based on this, the embodiments of the present invention provide a data transmission method in a vehicle communication interface apparatus and a vehicle communication interface apparatus, and the data transmission method in the vehicle communication interface apparatus and the vehicle communication interface apparatus can respond to a diagnostic command and receive diagnostic data simultaneously.

The vehicle communication interface apparatus in the embodiments of the present invention may be connected to an upper computer and a to-be-checked vehicle, to perform the data transmission method in the embodiments of the present invention.

The data transmission method in the embodiments of the present invention can be performed in any type of vehicle communication interface apparatus including a user interaction apparatus and a processor with a computing capability.

Specifically, the embodiments of the present invention are further described below with reference to accompanying drawings.

FIG. 1 is a schematic structural diagram of a vehicle diagnosis system according to an embodiment of the present invention. As shown in FIG. 1, the vehicle diagnosis system 100 includes an upper computer 10 and a vehicle communication interface apparatus 20. The upper computer 10 is connected to the vehicle communication interface apparatus 20, and the vehicle communication interface apparatus 20 is configured to connect to a vehicle 200.

The upper computer 10 may be specifically any proper terminal device that is provided with a vehicle diagnosis function and on which an intelligent operating system is run, such as a mobile phone, a tablet computer, or an intelligent wearable device. A user (for example, a vehicle owner) may perform interaction with the upper computer 10 by using one or more user interaction devices of any proper type (for example, a touchscreen, a mouse, a keyboard, a remote control, a motion sensing camera, and an audio capture apparatus), to input an instruction or control the upper computer 10 to perform one or more operations. Client software of any type such as a vehicle diagnosis APP may be installed on the upper computer 10. The upper computer performs communication connection with the vehicle communication interface apparatus 20 through the client software, to send an instruction to the vehicle communication interface apparatus 20 or obtain data of the vehicle communication interface apparatus 20.

The vehicle communication interface apparatus 20 may be a communication interface apparatus of a vehicle communication interface (VCI) type or another type. The vehicle communication interface apparatus 20 may be connected to an electronic control unit (ECU) in the vehicle 200 through an on-board diagnostics (OBD) system, to obtain diagnostic data in the vehicle 200 or transmit an instruction to the vehicle 200. The vehicle 200 may be an automobile, a tram, a train, a truck, or the like, and performs data transmission with the upper computer 10 through the corresponding vehicle communication interface apparatus. Specifically, the vehicle communication interface apparatus 20 is connected to a bus (for example, a CAN bus) of the ECU in the vehicle 200. Optionally, the vehicle communication interface apparatus 20 may be provided with a Wi-Fi module, a USB module, a Bluetooth module and a mobile network module, and may establish a connection to the upper computer 10 according to a requirement.

Based on the foregoing vehicle diagnosis system 100, in actual application, when a diagnosis needs to be performed on the vehicle 200, the user (the vehicle owner or a repair technician) may first connect to the vehicle 200 through the vehicle communication interface apparatus 20, to enable the vehicle communication interface apparatus 20 to read diagnostic data of the vehicle 200; and then establish a connection between the upper computer 10 and the vehicle communication interface apparatus 200, to enable the vehicle communication interface apparatus 20 to transmit the diagnostic data to the upper computer 10, or to receive a diagnostic command sent by the user through the upper computer 10, to perform a diagnosis on the vehicle 200.

It should be noted that the data transmission method in the vehicle communication interface apparatus according to the embodiments of the present invention may be further expanded to another proper implementation environment, and is not limited to the implementation environment shown in FIG. 1. Although FIG. 1 shows only one upper computer 10 and one vehicle communication interface apparatus 20, a person skilled in the art should understand that in an actual application process, the application environment may include more upper computers 10 and more vehicle communication interface apparatuses 20. This is not specifically limited in the embodiments of the present invention

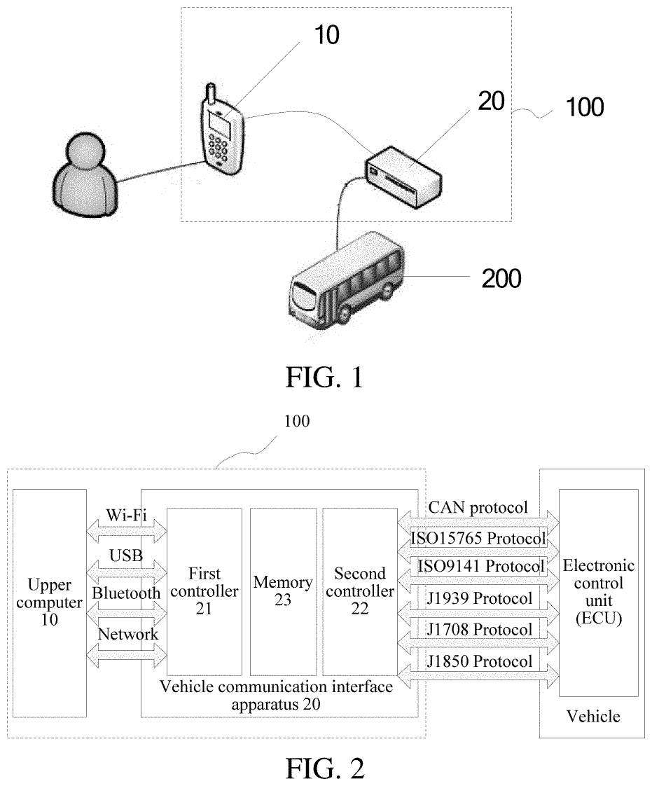

Referring to FIG. 2 together, the vehicle communication interface apparatus 20 includes a first controller 21 and a second controller 22.

The first controller 21 is configured to receive a diagnostic command sent by the upper computer 10, and store the diagnostic command into a first queue. The first controller 21 is further configured to obtain diagnostic data from a second queue, and send the diagnostic data to the upper computer 10.

The second controller 22 is configured to obtain the diagnostic command from the first queue, and send the diagnostic command to the ECU in the vehicle 200 connected to the vehicle communication interface apparatus 20. The second controller 22 is further configured to receive the diagnostic data from the ECU in the vehicle 200, and store the diagnostic data into the second queue, to make the first controller 21 obtain the diagnostic data from the second queue and send the diagnostic data to the upper computer 10.

The first controller 21 or the second controller 22 may further include a processor, an application-specific integrated circuit (ASIC) including a control processing function, a field programmable gate array (FPGA), a single chip microcomputer, and the like. Certainly, in some other embodiments, the vehicle communication interface apparatus 20 may further include other controllers, and two of the controllers may be selected to perform data transmission according to an actual requirement. This is not limited herein.

Optionally, as shown in FIG. 2, the vehicle communication interface apparatus 20 further includes a memory 23. The memory 23 may include a volatile memory, for example, a random access memory (RAM) such as a static random-access memory (SRAM) or a double data rate synchronous dynamic random access memory (DDR SDRAM); the memory may also include a non-volatile memory, such as a flash memory, a hard disk drive (HDD) or a solid-state drive (SSD), an electrically erasable programmable read only memory (EEPROM); and the memory may further include a combination of the foregoing various memories. The memory may be an independent memory, or may be a memory or a module including a storage function in a chip (for example, a processor chip). The memory may store computer programs (for example, a control program for an image capture apparatus, a vehicle diagnosis program, or a functional module), a computer instruction, an operating system, data, a database, and the like. The memory may store the foregoing content in different areas

In this embodiment, the memory 23 is connected to the first controller 21 and the second controller 22. The first queue and the second queue are disposed in the memory 23, to make the first controller 21 store the diagnostic command into the first queue or obtain the diagnostic data from the second queue, and to make the second controller 22 obtain the diagnostic command from the first queue or store the diagnostic data into the second queue.

It may be understood that, in some other embodiments, two or more memories may be disposed in the vehicle communication interface apparatus 20. The first queue and the second queue are respectively disposed in different memories, and the two memories are respectively connected to the first controller 21 and the second controller 22, to implement data transmission.

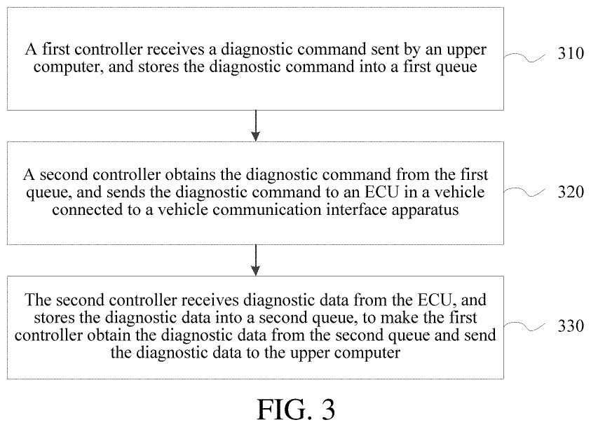

Referring to FIG. 3, FIG. 3 is a schematic flowchart of a data transmission method in a vehicle communication interface apparatus according to an embodiment of the present invention. As shown in FIG. 3, the data transmission method is applied to the vehicle communication interface apparatus 20 in the foregoing embodiment, and the method includes:

S310. A first controller receives a diagnostic command sent by an upper computer, and stores the diagnostic command into a first queue.

In this embodiment, the “diagnostic command” may include a diagnostic identification command, a verification command, and the like. For example, diagnostic data of a corresponding vehicle module may be obtained through the diagnostic identification command, and whether the upper computer includes a diagnostic qualification is verified through the verification command. The upper computer may receive or transmit the diagnostic command. For example, the upper computer receives a diagnostic command from a user, or the upper computer transmits a diagnostic command sent by a terminal. In actual application, when a diagnosis needs to be performed on a vehicle, a communication connection to the vehicle 200 may be first established through the vehicle communication interface apparatus 20, and then the user enters a diagnostic command related to the vehicle 200 and the vehicle communication interface apparatus 20 through the upper computer 10, and instructs the upper computer 10 to send the diagnostic command to the vehicle communication interface apparatus 20, to perform a vehicle diagnosis.

In this embodiment, a specific implementation of receiving the diagnostic command sent by the upper computer may be: determining whether the upper computer sends the diagnostic command, and if the upper computer sends the diagnostic command, receiving the diagnostic command sent by the upper computer.

In this embodiment, when the first controller 21 receives the diagnostic command sent by the upper computer, the first controller 21 stores the diagnostic command into the first queue in the memory 23.

S320. A second controller obtains the diagnostic command from the first queue, and sends the diagnostic command to an ECU in a vehicle connected to a vehicle communication interface apparatus.

In this embodiment, after the first controller 21 stores the diagnostic command into the first queue in the memory 23, the second controller 22 obtains the diagnostic command from the first queue and sends the diagnostic command to the ECU in the vehicle 200 connected to the vehicle communication interface apparatus 20, to make the vehicle 200 receive the diagnostic command sent by the upper computer 10.

S330. The second controller 22 receives diagnostic data from the ECU, and stores the diagnostic data into a second queue, to make the first controller obtain the diagnostic data from the second queue and send the diagnostic data to the upper computer.

In this embodiment, the “diagnostic data” may be diagnostic data of some or all modules of the vehicle, and for example, may include current data information and historical data information of a motor module and a battery module. In actual application, the second controller 22 is connected to a bus of the ECU in the vehicle 200, so that the second controller 22 may receive the diagnostic data of the ECU. Optionally, the ECU may upload the diagnostic data regularly according to preset duration, to make the second controller 22 regularly receive the diagnostic data uploaded by the ECU.

In this embodiment, when the second controller 22 receives the diagnostic data, the second controller 22 stores the diagnostic data into the second queue of the memory 23. After the second controller 22 stores the diagnostic data into the second queue, the first controller 21 may obtain the diagnostic data from the second queue, to transmit the diagnostic data to the upper computer 10.

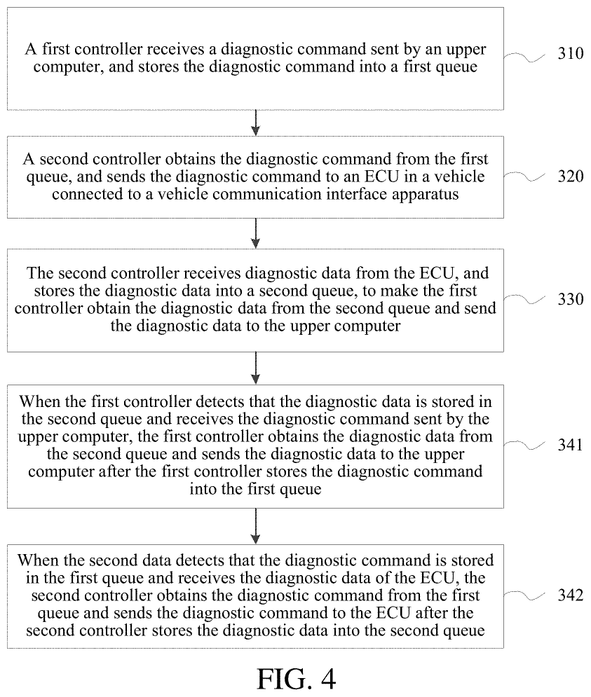

Optionally, priorities are preset for processing of the diagnostic data and the diagnostic command. For example, if the priority of the diagnostic command is set to be higher than that of the diagnostic data, the diagnostic command is preferentially processed. In the first controller 21, when the priority of the diagnostic command is preset to be higher than that of the diagnostic data, as shown in FIG. 4, the method further includes:

S341. When the first controller detects that the diagnostic data is stored in the second queue and receives the diagnostic command sent by the upper computer, the first controller obtains the diagnostic data from the second queue and sends the diagnostic data to the upper computer after the first controller stores the diagnostic command into the first queue.

When the upper computer 10 sends the diagnostic command to the first controller 21 and the diagnostic data is stored in the second queue of the memory 23, the first controller 21 preferentially responds to the diagnostic command of the upper computer 10 and processes the diagnostic command, and then obtains the diagnostic data and sends the diagnostic data to the upper computer 10, so that the diagnostic command can be responded to quickly.

Optionally, in the second controller 22, when the priority of the diagnostic data is preset to be higher than that of the diagnostic command, as shown in FIG. 4, the method further includes:

S342. When the second data detects that the diagnostic command is stored in the first queue and receives the diagnostic data of the ECU, the second controller obtains the diagnostic command from the first queue and sends the diagnostic command to the ECU after the second controller stores the diagnostic data into the second queue.

When the ECU of the vehicle 200 uploads the diagnostic data, and the diagnostic command is stored in the first queue of the memory 23, after the second controller 22 preferentially responds to the diagnostic data of the vehicle 200 and processes the diagnostic data, and then obtains the diagnostic command and sends the diagnostic command to the ECU of the vehicle 200, so that the diagnostic data can be responded to quickly.

It is necessary to be noted that an execution sequence of S310, S320, and S330 may be changed. For example, the execution sequence may be S330, S320, and S310. S341 and S342 may be performed simultaneously or may not be performed simultaneously, or only one of them is selected and performed

In this embodiment, according to the data transmission method, the first controller 21 receives the diagnostic command sent by the upper computer 10 and stores the diagnostic command into the first queue, and the second controller 22 obtains the diagnostic command from the first queue and sends the diagnostic command to the vehicle 200. The second controller 22 further receives the diagnostic data from the vehicle 200 and stores the diagnostic data into the second queue, and the first controller 21 further obtains the diagnostic data from the second queue, thereby responding to the diagnostic command and receiving the diagnostic data simultaneously in the vehicle communication interface apparatus 20, to enable the vehicle communication interface apparatus 20 to perform data communication with the upper computer 10 and the vehicle 200 simultaneously, to avoid missing the diagnostic data or the diagnostic command.

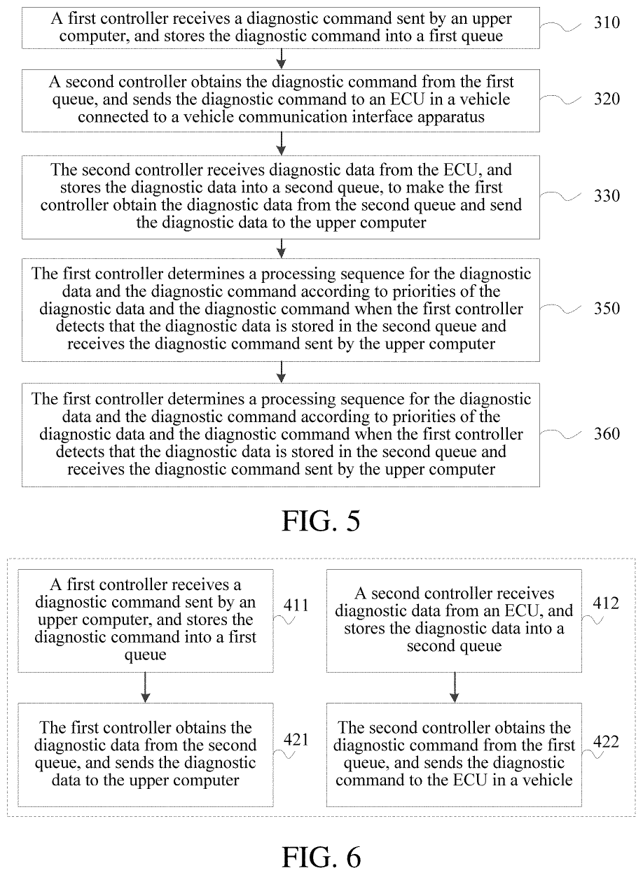

Based on the foregoing embodiment, an embodiment of the present invention further provides another data transmission method in a vehicle communication interface apparatus shown in FIG. 5. Specifically, as shown in FIG. 5, a difference between this embodiment and the foregoing embodiment lies in that:

In this embodiment, the vehicle communication interface apparatus 20 may determine the priorities of the diagnostic data and the diagnostic command, to determine a processing sequence for the diagnostic data and the diagnostic command. The data transmission method further includes:

S350. The first controller determines a processing sequence for the diagnostic data and the diagnostic command according to priorities of the diagnostic data and the diagnostic command when the first controller detects that the diagnostic data is stored in the second queue and receives the diagnostic command sent by the upper computer.

In this embodiment, “priorities of diagnostic data” refer to priorities of a plurality of pieces of diagnostic data stored in the second queue. The priority of the diagnostic data may be determined according to a data size of the diagnostic data and/or storage duration of the diagnostic data in the second queue. For example, a greater data volume of the diagnostic data is preset to have a higher priority. Assuming that the diagnostic data includes diagnostic data A and diagnostic data B, if the data volume of the diagnostic data A is greater than the data volume of the diagnostic data B, it is determined that the priority of the diagnostic data A is higher than that of the diagnostic data B, and the diagnostic data A is preferentially processed. For another example, longer storage duration of the diagnostic data in the second queue is preset to have a higher priority. It is assumed that the diagnostic data includes diagnostic data A and diagnostic data B, the storage duration of the diagnostic data A in the second queue is 1.1 s, and the storage duration of the diagnostic data B in the second queue is 1 s, so that the storage duration of the diagnostic data A in the second queue is greater than the storage duration of the diagnostic data B in the second queue. Then it is determined that the priority of the diagnostic data A is higher than that of the diagnostic data B, and the diagnostic data A is preferentially processed. For still another example, a greater data volume of the diagnostic data is preset to have a higher priority, longer storage duration of the diagnostic data in the second queue is preset to have a higher priority, and occupied proportions of the data size and the storage duration are respectively 60% and 40%. If the data volume of the diagnostic data A is greater than the data volume of the diagnostic data B, and the storage duration of the diagnostic data A is greater than the storage duration of the diagnostic data B, it is determined that the priority of the diagnostic data A is higher than that of the diagnostic data B.

In this embodiment, “priorities of diagnostic commands” refer to priorities of a plurality of diagnostic commands stored in the first queue. The priority of the diagnostic command may be determined according to urgency and/or importance of the diagnostic command. The “urgency” may be determined according to a sequence in which the diagnostic commands are stored into the first queue. For example, if a diagnostic command C is first stored into the first queue, and a diagnostic command D is then stored into the first queue, the urgency of the diagnostic command C is higher than the urgency of the diagnostic command D, and the priority of the diagnostic command C is higher than the priority of the diagnostic command D. The “importance” may be preset according to the type of the diagnostic command. For example, the importance of a security-class diagnostic command is set to be greater than the importance of a routine-class diagnostic command. The importance of the diagnostic command is preset, and a specific implementation may be: carrying an importance identifier in the diagnostic command. For example, if the diagnostic command C carries a low-level importance identifier, the diagnostic command D carries a high-level importance identifier, the priority of the diagnostic command C is higher than the priority of the diagnostic command D. When the priority of the diagnostic command is jointly determined according to the urgency and the importance of the diagnostic command, preset proportions may be set, and for example, occupied proportions of the urgency and the importance are respectively 60% and 40%, and the priority is determined according to the urgency, the importance, and the occupied proportions of the urgency and the importance.

In S350, the determining, by the first controller, a processing sequence for the diagnostic data and the diagnostic command according to priorities of the diagnostic data and the diagnostic command may include:

S351. The first controller compares the priority of the diagnostic command with the priority of the diagnostic data according to a preset rule.

S352. The first controller first processes one of the diagnostic command and the diagnostic data of which the priority is higher.

The “preset rule” includes: presetting a correspondence between the priority of the diagnostic command and the priority of the diagnostic data, and converting the priority of one of the diagnostic command and the diagnostic data into the priority of the other one of the diagnostic command and the diagnostic data according to the correspondence. For example, the preset correspondence between the priority of the diagnostic command and the priority of the diagnostic data is that by being multiplied by 0.6, the priority of the diagnostic data is converted into the priority of the diagnostic command. Assuming that the priorities of the diagnostic data A and the diagnostic data B in the diagnostic data are respectively 60% and 40% and the priorities of the diagnostic command C and the diagnostic command D in the diagnostic command are respectively 70% and 30%, the priorities of the diagnostic command C and the diagnostic command D in the diagnostic data are 42% and 18%, and the priorities in descending order are respectively the diagnostic data A, the diagnostic command C, the diagnostic data B, and the diagnostic command D. Certainly, in some other embodiments, the preset correspondence between the priority of the diagnostic command and the priority of the diagnostic data may be another one, and may be set according to an actual use requirement.

In this embodiment, when determining the priority of the diagnostic command and the priority of the diagnostic data, the first controller preferentially processes one of the diagnostic command and the diagnostic data of which the priority is higher according to the priority of the diagnostic command and the priority of the diagnostic data, to enable the diagnostic command or the diagnostic data to be responded to quickly.

Optionally, in some other embodiments, the data transmission method further includes:

S360. The second controller determines a processing sequence for the diagnostic data and the diagnostic command according to priorities of the diagnostic data and the diagnostic command when the second controller detects that the diagnostic command is stored in the first queue and receives the diagnostic data sent by the ECU.

In S360, the determining, by the second controller, a processing sequence for the diagnostic data and the diagnostic command according to priorities of the diagnostic data and the diagnostic command may include:

S361. The second controller compares the priority of the diagnostic command with the priority of the diagnostic data according to a preset rule.

S362. The second controller first processes one of the diagnostic command and the diagnostic data of which the priority is higher.

It is necessary to be noted that the preset rule in the first controller and the preset rule in the second controller may be the same or may be different, and may be determined according to an actual use scenario.

In this embodiment, the vehicle communication interface apparatus 20 may determine the priorities of the diagnostic data and the diagnostic command, to determine the processing sequence for the diagnostic data and the diagnostic command. In this way, the vehicle communication interface apparatus 20 may respond to the diagnostic command and receive the diagnostic data according to a requirement, so that the vehicle communication interface apparatus 20 may perform data communication with the upper computer 10 and the vehicle 200, to avoid missing the diagnostic data or the diagnostic command.

Referring to FIG. 6, FIG. 6 is a schematic flowchart of an application example of a data transmission method in a vehicle communication interface apparatus according to an embodiment of the present invention. As shown in FIG. 6,

S411. A first controller receives a diagnostic command sent by an upper computer, and stores the diagnostic command into a first queue;

S412. A second controller receives diagnostic data from an ECU, and stores the diagnostic data into a second queue;

S421. The first controller obtains the diagnostic data from the second queue, and sends the diagnostic data to the upper computer.

S422. The second controller obtains the diagnostic command from the first queue, and sends the diagnostic command to the ECU in a vehicle.

S411 and S412 may be performed simultaneously or may not be performed simultaneously, and S421 and S422 may be performed simultaneously or may not be performed simultaneously.

In this embodiment, by presetting the priority of the diagnostic command to be higher than the priority of the diagnostic data in the first controller and the priority of the diagnostic data to be higher than the priority of the diagnostic command in the second controller, the vehicle communication interface apparatus 20 may perform processing according to the preset priorities of the diagnostic data and the diagnostic command, so that the vehicle communication interface apparatus 20 may perform data communication with the upper computer 10 and the vehicle 200 simultaneously, to avoid missing the diagnostic data or the diagnostic command.

The apparatus embodiments described above are merely exemplary, where the units described as separated parts may be or may not be physically separated, and parts displayed as units may be or may not be physical units. That is, the parts may be located in the same place, or may be distributed to a plurality of network units. Some or all of the modules may be selected according to an actual requirement to implement the objective of the solution of this embodiment.

Based on the descriptions of the foregoing implementations, a person skilled in the art should clearly understand that the implementations may be implemented by using software and a hardware platform, or may be implemented by using hardware. A person skilled in the art may understand that all or some of the processes in the method of the foregoing embodiment may be completed by using computer programs in a computer program product to instruct corresponding hardware, and the computer programs may be stored in a non-transient computer-readable storage medium. The computer programs include program instructions, and the program instructions, when being performed by a related device, cause the related device to perform the procedure of the embodiments of the foregoing methods. The storage medium may be a magnetic disk, an optical disc, a read-only memory (ROM) or a random access memory (RAM), or the like.

The product may perform the data transmission method provided in the embodiments of the present invention, and includes corresponding functional modules and beneficial effects for performing the data transmission method. For technical details not described in detail in the embodiments, reference may be made to the data transmission method provided in the embodiments of the present invention.

It should be finally noted that, the foregoing embodiments are merely used for describing the technical solution of the present invention and are not intended to limit the present invention. Based on the idea of the present invention, technical features in the foregoing embodiment or different embodiments may be combined, the steps may be implemented in any sequence, various other variations on different aspects of the present invention also exist, and for brevity, they are not provided in detail. Although detailed descriptions of the present invention are performed with reference to the foregoing embodiments, a person skilled in the art should understand that, modifications may be performed on the technical solutions recorded in the foregoing embodiments, or equivalent replacement may be performed on some technical features, and these modifications or replacements may not make the essence of the corresponding technical solutions depart from the scope of the technical solutions of the embodiments of the present invention.

What is claimed is:

1. A data transmission method in a vehicle communication interface apparatus, wherein the vehicle communication interface apparatus comprises a first controller and a second controller, and the method comprises:
receiving, by the first controller, a diagnostic command sent by an upper computer, and storing the diagnostic command into a first queue;
obtaining, by the second controller, the diagnostic command from the first queue, and sending the diagnostic command to an electronic control unit (ECU) in a vehicle connected to the vehicle communication interface apparatus; and
receiving, by the second controller, diagnostic data from the ECU, and storing the diagnostic data into a second queue, to make the first controller obtain the diagnostic data from the second queue and send the diagnostic data to the upper computer.

2. The method according to claim 1, wherein the method further comprises:
determining, by the first controller, a processing sequence for the diagnostic data and the diagnostic command according to priorities of the diagnostic data and the diagnostic command when the first controller detects that the diagnostic data is stored in the second queue and receives the diagnostic command sent by the upper computer.

3. The method according to claim 2, wherein
the priority of the diagnostic data is determined according to a data size of the diagnostic data and/or storage duration of the diagnostic data in the second queue; and
the priority of the diagnostic command is determined according to urgency and/or importance of the diagnostic command.

4. The method according to claim 3, wherein the determining, by the first controller, a processing sequence for the diagnostic data and the diagnostic command according to priorities of the diagnostic data and the diagnostic command comprises:
comparing, by the first controller, the priority of the diagnostic command with the priority of the diagnostic data according to a preset rule; and
first processing, by the first controller, one of the diagnostic command and the diagnostic data of which the priority is higher, wherein
the preset rule comprises:
presetting a correspondence between the priority of the diagnostic command and the priority of the diagnostic data, and converting the priority of one of the diagnostic command and the diagnostic data into the priority of the other one of the diagnostic command and the diagnostic data according to the correspondence.

5. The method according to claim 1, wherein the method further comprises:
when the first controller detects that the diagnostic data is stored in the second queue and receives the diagnostic command sent by the upper computer, obtaining, by the first controller, the diagnostic data from the second queue and sending the diagnostic data to the upper computer after the first controller stores the diagnostic command into the first queue.

6. A vehicle communication interface apparatus, wherein the vehicle communication interface apparatus comprises a first controller and a second controller,
the first controller is configured to receive a diagnostic command sent by an upper computer, and store the diagnostic command into a first queue;
the second controller is configured to obtain the diagnostic command from the first queue, and send the diagnostic command to an ECU in a vehicle connected to the vehicle communication interface apparatus; and
the second controller is further configured to receive diagnostic data from the ECU, and store the diagnostic data into a second queue, to make the first controller obtain the diagnostic data from the second queue and send the diagnostic data to the upper computer.

7. The vehicle communication interface apparatus according to claim 6, wherein
the first controller is further configured to determine a processing sequence for the diagnostic data and the diagnostic command according to priorities of the diagnostic data and the diagnostic command when the first controller detects that the diagnostic data is stored in the second queue and receives the diagnostic command sent by the upper computer.

8. The vehicle communication interface apparatus according to claim 7, wherein
the priority of the diagnostic data is determined according to a data size of the diagnostic data and/or storage duration of the diagnostic data in the second queue; and
the priority of the diagnostic command is determined according to urgency and/or importance of the diagnostic command.

9. The vehicle communication interface apparatus according to claim 8, wherein the first controller is specifically configured to:
compare the priority of the diagnostic command with the priority of the diagnostic data according to a preset rule; and
first process one of the diagnostic command and the diagnostic data of which the priority is higher, wherein
the preset rule comprises:
presetting a correspondence between the priority of the diagnostic command and the priority of the diagnostic data, and converting the priority of one of the diagnostic command and the diagnostic data into the priority of the other one of the diagnostic command and the diagnostic data according to the correspondence.

10. The vehicle communication interface apparatus according to claim 1, wherein
the first controller is further configured to, when the first controller detects that the diagnostic data is stored in the second queue and receives the diagnostic command sent by the upper computer, obtain the diagnostic data from the second queue and send the diagnostic data to the upper computer after the first controller stores the diagnostic command into the first queue.
